(19) United States
(12) Patent Application Publication
(10) Pub. No.: US 2024/0241854 A1
(43) Pub. Date: Jul. 18, 2024

(54) APPARATUS AND METHOD

(71) Applicant: Intel Corporation, Santa Clara, CA (US)

(72) Inventors: Garrett CLAY, Beaverton, OR (US); Jaemon FRANKO, Gig Harbor, WA (US); Heung-for CHENG, Hillsboro, OR (US)

(21) Appl. No.: 18/619,217

(22) Filed: Mar. 28, 2024

Related U.S. Application Data
(60) Provisional application No. 63/551,110, filed on Feb. 8, 2024.

(51) Int. Cl. G06F 15/80; G06F 1/20

(52) U.S. Cl. CPC G06F 15/80; G06F 1/206

(57) ABSTRACT

Some aspects of the present disclosure relate to an apparatus comprising memory circuitry, machine-readable instructions, and processor circuitry to execute the machine-readable instructions to obtain a physical layout of a first processor circuitry comprising a plurality of processor cores and thermal information of the plurality of processor cores and to determine a first processor core of the plurality of processor cores to execute a first work-load based on the physical layout of the first processor circuitry and the thermal information of the plurality of processor cores.

### Background

Task schedulers are an important component in a computing environment, orchestrating the allocation of computational tasks to appropriate processing units to ensure efficient execution and resource utilization. A scheduler may operate at various levels within a system, such as the operating system thread level and application level and may be designed to optimize the performance and responsiveness of computing systems. It may be a challenge for schedulers to adapt to specific characteristics and configurations of an underlying hardware. This limitation may lead to less-than-optimal task distribution, impacting the system's overall performance and efficiency.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus or device;

FIG. 2 illustrates a block diagram of an example of an apparatus or device;

FIG. 3 illustrates a temperature measurement distribution across a processor circuitry comprising a plurality of processor cores, by a core adjacency unaware scheduler;

FIG. 4 illustrates a temperature measurement distribution across a processor circuitry comprising a plurality of processor cores, by a core adjacency aware scheduler;

FIG. 5 illustrates a core temperature comparison for the system of FIG. 3 and the system of FIG. 4;

FIG. 6 illustrates a flowchart of an example of a method; and

FIG. 7 illustrates a flowchart of an example of a method.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” maybe used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” mayindicate elements are in direct physical or electrical contact with each other and “coupled” mayindicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

Task schedulers, for instance operating system (OS) thread-and application-level schedulers, may assign work to compute resources. Current schedulers may not be aware of a physical layout of processor cores or their thermal characteristics. This may lead to greater power consumed by a cooling system, reduced core performance and/or result in greater part degradation due to inefficient distribution of temperature-increasing workloads on the die.

Some approaches, with respect to part degradation, include a scheduler that assigns work using a round-robin methodology since this may create a more even wear of the cores. However, this is a blind approach since it may not account for a core layout nor does it consider the core temperatures which could result in greater thermal degradation if they are being heated more often by adjacent cores.

Some schedulers may consider many parameters (such as Non-Uniform Memory Access, or NUMA, affinity) when assigning work to cores. According to the present disclosure a scheduler may add the physical layout of (processor) cores and their thermal characteristics to the parameters considered. The proposed scheduler may assign work to cores that are physically distant and therefore less prone to performance limitations from thermal throttling.

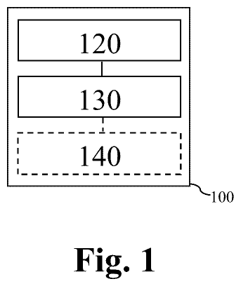

FIG. 1 illustrates a block diagram of an example of an apparatus 100 or device 100. The apparatus 100 comprises circuitry that is configured to provide the functionality of the apparatus 100. For example, the apparatus 100 of FIG. 1 comprises interface circuitry 120, processor circuitry 130 and (optional) storage circuitry 140. For example, the processor circuitry 130 may be coupled with the interface circuitry 120 and optionally with the storage circuitry 140.

For example, the processor circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1a comprises means for processing 130, which may correspond to or be implemented by the processor circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processor circuitry 130 or means for processing 130 may be implemented by the processor circuitry 130 or means for processing 130 executing machine-readable instructions. Accordingly, any feature ascribed to the processor circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processor circuitry 130 or means for processing 130 may be implemented using one or more processing units, one or more processing devices, any means for processing, such as a processor, a computer or a programmable hardware component being operable with accordingly adapted software. In other words, the described function of the processor circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage. For example, the storage circuitry 140 may store a (UEFI) BIOS.

The processor circuitry 130 is configured obtain a physical layout of a first processor circuitry comprising a plurality of processor cores and thermal information of the plurality of processor cores. The processor circuitry 130 is configured to determine a first processor core of the plurality of processor cores to execute a first workload based on the physical layout of the first processor circuitry and the thermal information of the plurality of processor cores.

In some examples, the first processor circuitry may be the same as the processor circuitry 130. In this case, for instance, the circuitry 130 may obtain the physical layout of the first processor circuitry from a storage circuitry 140. For example, the first processor core of the processor circuitry 130 may execute the first workload.

In some examples, the first processor circuitry may be different from the processor circuitry 130. In this case, for instance, the circuitry 130 may obtain the physical layout of the first processor circuitry via the interface circuitry 120 from another apparatus comprising the first processor circuitry. For example, the determined first processor core is transmitted to the first processor circuitry via the interface circuitry 120.

The physical layout of the first processor circuitry comprising a plurality of processor cores may be a spatial representation of the processor cores within the first processor circuitry. In some examples, the physical layout of the first processor circuitry may be spatial representation also comprising other components of the first processor circuitry such as interconnects, memory controllers, power management, I/O interfaces etc. In some examples, the physical layout of the first processor circuitry may be a 2 dimensional (2D) or 3 dimensional spatial representation of components of the first processor circuitry. That is the physical layout may comprise components which are arranged in a plane or in stacked layers to represent their spatial position within the first processor circuitry.

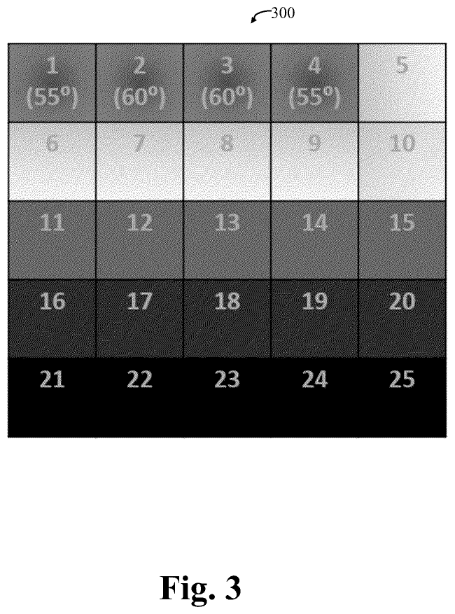

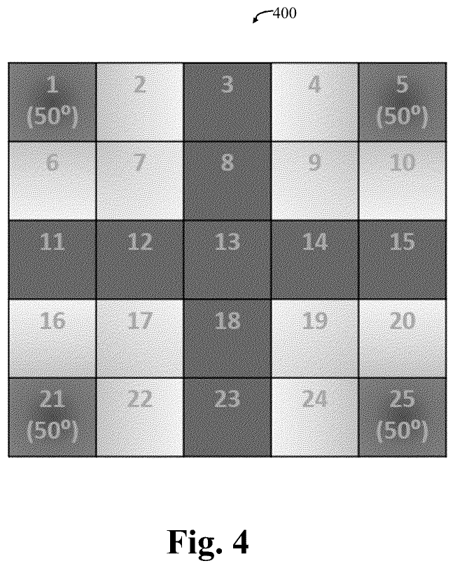

In some examples, the physical layout comprises at least a spatial positioning of the processor cores within the processor circuitry. In some examples, the physical layout comprises at least a spatial positioning of the processor cores relative to each other within a 2-dimensional plane within the processor circuit (see FIGS. 3 and 4). For instance, the spatial physical layout may

In some examples, the physical layout of the first processor circuitry may be determined during a manufacturing process of the first processor circuitry, for instance, be a silicon manufacturing company. In another examples, the physical layout of the first processor circuitry may be determined by applying power-intensive workloads to the processor cores of the first processor circuitry measuring the corresponding temperature profile of the processor cores (and in some examples also of other components) and inferring the physical layout based thereon. This is explained in more detail below. For instance, the physical layout of the first processor circuitry may be determined by the circuitry 130 or by another apparatus and be transmitted to the circuitry 130.

In some examples, the thermal information of the plurality of processor cores may comprise a temperature measurement for each of the plurality of cores. The apparatus 100, for example the circuitry 130 may comprise sensors to measure the temperature of the plurality of processor cores.

In some examples the thermal information of the plurality of processor cores may comprise a thermal throttle threshold for each of the plurality of cores. The thermal throttle threshold for a processor core, may indicate the maximum temperature limit beyond which the core will reduce its performance to prevent overheating. In some examples the thermal information of the plurality of processor cores may comprise a heat dissipation value for each of the plurality of cores. The heat dissipation value for each core, may indicate the amount of heat each core can emit during a certain period of time, that is how fast a processor core may cool down.

The processor circuitry 130 is configured to determine the first processor core of the plurality of processor cores to execute the first workload based on the physical layout of the first processor circuitry and the thermal information of the plurality of processor cores. In other words, the assigning of the workload to a specific processor core takes also into account (may be beside other factors) the current temperature measurement of the processor cores and their corresponding spatial position within the physical layout of the processor circuitry.

In some examples, the workload may be a task, a process, an application, or a virtual machine. That is the workload may refer to a single task, which is a specific operation or a small sequence of operations or it may refer to a process, which is a program in execution that contains one or more tasks. The workload may also refer to application, which may be complete software program designed for end-users. In some examples, the workload may refer to a virtual machine, which is an emulation of a computer system that provides the functionality of a physical computer, allowing multiple instances to run on a single physical hardware resource. In some examples, the processor circuitry 130 may be configured to assign the first workload to the first processor core. The first processor core may then execute the first workload.

This temperature based scheduling of workloads as described in this disclosure may result in spreading the workload-generated heat more evenly across the first processor circuitry. Therefore, the cooling system of the first processor circuitry may require less energy which leads to an increased energy efficiency. Still further, the thermal degradation of the first processor circuitry or of parts of it may be more evenly spread which increase the longevity of the first processor circuitry. Still further, when a processor core hits thermal throttle threshold it may reduce its clock speed or power consumption to decrease heat generation which results in a performance loss. Therefore, due to the temperature based scheduling of workloads as described in this disclosure, processor cores may be less likely to hit their thermal throttle threshold, which may lead to a better performance.

In some examples, a pre-existing scheduling algorithm may be used wherein the current temperature measurement of the processor cores and their corresponding spatial position within the physical layout of the processor circuitry are integrated as an additional factor to the decide which processor core should execute the first workload.

### Determining a Processor Core

For example, the circuitry 130 may configured to determine the first processor core of the plurality of processor cores to execute the first workload, only among the processor cores of the for processor circuitry which are not executing any workload at the moment. For example, the circuity 130 may be configured to determine a processor core for new workloads, i.e., a workload where execution may have not been started yet.

In some examples, the circuitry 130 may configured to determine the first processor core of the plurality of processor cores to execute the first workload, wherein the first processor core has a lowest temperature measurement among the plurality of processor cores of the processor circuitry. In some examples, the circuitry 130 may configured to determine the first processor core of the plurality of processor cores to execute the first workload, wherein the first processor has a temperature that is below a predetermined value. For instance, the first processor core is chosen because it has a temperature below 40° C., or 50° C., or 60° C. or the like.

In some examples, the circuitry 130 may configured to determine the first processor core of the plurality of processor cores to execute the first workload, wherein the first processor core has a temperature below the average temperature of the plurality of processor cores. Average temperature of the plurality of processor cores may generally refer to a representative value that summarizes the temperatures across multiple processor cores. For example, average temperature of the plurality of processor cores may refer to the mean (total of all core temperatures divided by the number of cores), other statistical measures like the median (the middle value when core temperatures are ranked) or the mode (the most common temperature value) or the like.

In some examples, the processor circuitry 130 may be configured to determine a division of the physical layout of the first processor circuitry into a plurality of areas, wherein each of area of the plurality of areas comprises one or more processor cores of the plurality of processor cores. For example, the physical layout may be divided into a number of equally sized areas. For example, each area of the plurality of areas comprises an equal number of processors cores of the plurality of processor cores. For example, each area of the plurality of areas comprises between 2 to 10 processors cores of the plurality of processor cores.

In another example, the one or more areas may comprise a different amount of processor cores.

In some examples, the processor circuitry 130 may be configured to determine the first processor core as being part of a first area of the plurality of areas. The first area may have the lowest average processor core temperature measurement. For example, after dividing the physical layout of the first processor circuitry into a plurality of areas, wherein each area comprises one or more processor core, an average temperature for each area is determined.

For example, the average temperature may refer to the mean temperature of all processor cores of an area (average is to be understood as described above). The area with the lowest average temperature may be referred to as the first area. If there is more than one processor core in the first area then, in some examples, the first processor core is randomly chosen among the processor cores in the first area. In another example, the first processor core is determined as a processor core with the lowest processor core temperature measurement in the first area.

### Determine a Second Processor Core

In some examples, the processor circuitry 130 may be configured to determine a second processor core of the plurality of processor cores to execute a second workload based on the physical layout of the first processor circuitry, based on the thermal information of the plurality of processor cores and/or based on the determined first processor core executing the first workload. In some examples, the processor circuitry 130 may be configured to determine the second processor core based on the spatial position determined first processor core executing the first workload within the physical layout of the first processor circuitry. In other words, the assignment of the second workload to the second processor core may be further based on the assignment of the first workload to the first processor core done before (or the other way round).

For example, the second processor core may be determined in such a way that a predetermined spatial relationship within the physical layout of the first processor circuitry is maintained between the first processor core and the second processor core. For example, the second processor core is determined in such a way that there is a predetermined distance between the first processor core and the second processor core-i.e. a predetermined number of processor cores.

In some examples, the first processor core and/or the second processor core are determined such that the first processor core and the second processor core are not adjacent processor cores within the physical layout of the first processor circuitry. For instance, the first processor core may neither share a plane (in case of 3D layout) nor an edge nor a corner. In some cases, they may share a corner and not considered adjacent.

In some examples, the first processor core and/or the second processor core are determined such that the first processor core and the second processor core have a predetermined spacing, a predetermined number of processor cores is between the first processor core and the second processor core. The predetermined number of processor cores between the first processor core and the second processor core may be counted as the number of processor cores that have to be traversed to get from the first processor core to the second processor core.

In some examples, the first processor core and/or the second processor core are determined such that maximum possible spacing within the physical layout is between the first processor and the second processor. The maximum possible spacing may refer to a maximum distance measure between the two process cores (may be from the center of the first processor core to the center of the second processor) or it may refer to a maximum number of processor cores between the two processor cores.

For instance, the first processor core is first determined to execute the first workload then the second processor core is determined such that the condition as above are fulfilled. If the second processor core is first determined to execute the second workload, then the first processor core is determined such that the condition as above are fulfilled.

In case that the first processor core is first determined to execute the first workload then processor circuitry 130 may be configured to determine the second processor core as being part of a second area of the plurality of areas, the second area having the second lowest average processor core temperature measurement. The plurality of areas and the corresponding average temperature may be determined as described above. The first processor core may have been determined to be part of the first area with the lowest average processor core temperature measurement.

As described with regards to the first area, in some examples, the second processor core is randomly chosen among the processor cores in the second area. In another example, the second processor core is chosen as the processor core with the lowest processor core temperature measurement in the second area.

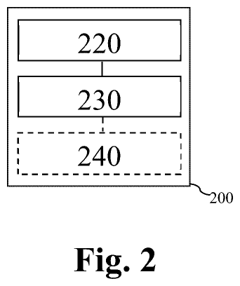

Further details and aspects are mentioned in connection with the examples described below. The example shown in FIG. 1 mayinclude one or more optional additional features corresponding to one or more aspects mentioned in connection with the proposed concept or one or more examples described below (e.g., FIGS. 2-7).

### Reallocate a Workload

FIG. 2 illustrates a block diagram of an example of an apparatus 200 or device 200. The apparatus 200 comprises circuitry that is configured to provide the functionality of the apparatus 200. For example, the apparatus 200 of FIG. 2 comprises interface circuitry 220, processor circuitry 230 and (optional) storage circuitry 240. For example, the processor circuitry 230 may be coupled with the interface circuitry 220 and optionally with the storage circuitry 240. For example, the processor circuitry 230 may be configured to provide the functionality of the apparatus 200, in conjunction with the interface circuitry 220. For example, the interface circuitry 220 is configured to exchange information, e.g., with other components inside or outside the apparatus 200 and the storage circuitry 240. Likewise, the device 200 may comprise means that is/are configured to provide the functionality of the device 200.

The apparatus 200 and the interface circuitry 220, the processor circuitry 230 the storage circuitry 240 may be identical or different to the apparatus 100 and its circuitry.

In some examples, the circuity 230 may be configured move executing workloads from a current processor core to another processor core within the processing circuitry in case that the current processor core may be thermally throttled due to high temperature. For example, the current processor core and the another processor core are physically distant within the physical layout and therefore less likely to be affected by temperature from adjacent cores.

In some examples, the processor circuitry 230 may be configured to obtain a physical layout of a first processor circuitry comprising a plurality of processor cores and thermal information of the plurality of processor cores. Further, the processor circuitry 230 may be configured to identify a first processor core of the plurality of processor cores which is executing a first workload based on a thermal information of the first processor core. For instance, the first processor core is identified as the processor core with the highest current temperature among the plurality of processor cores. In another example, the first processor core is identified as the first processor core to exceed its predefined thermal throttle threshold. In another example, the first processor core is identified as the processor core exceeding its predefined thermal throttle threshold the most in percentage terms or in absolute temperatures.

Further, the processor circuitry 230 may be configured to determine a second processor core of the plurality of processor cores to execute the first workload based on the physical layout of the first processor circuitry and the thermal information of the plurality of processor cores. The second processor core may be determined as described above (with regards to the first or the second processor core as described above). For example, the second processor core may be the processor core with the lowest temperature measurement.

In another example, the second processor core may be determined in such a way that a predetermined spatial relationship within the physical layout of the first processor circuitry is maintained between the first processor core and the second processor core (see above for different examples in this regard). For example, the second processor core is determined in such a way that there is a predetermined distance between the first processor core and the second processor core-i.e. a predetermined number of processor cores.

In some examples, a temperature measurement of the first core is higher than a temperature measurement of the second core.

Further, the processor circuitry 230 may be configured to assign the first workload to the second processor core. In other words, the first workload that is executed by one processor core and causes temperature-related thermal difficulties is reallocated to another processor core that is in a more favorable thermal state.

This temperature based re-allocation of workloads as described in this disclosure may result in spreading the workload-generated heat more evenly across the first processor circuitry.

Therefore, the cooling system of the first processor circuitry may require less energy which leads to an increased energy efficiency. Still further, the thermal degradation of the first processor circuitry or of parts of it may be more evenly spread which increase the longevity of the first processor circuitry. Further, the temperature based re-scheduling of workloads as described in this disclosure increases performance because processor cores that may have reached a thermal throttle threshold are relieved.

### Example of Determining the Physical Layout of the First Processor Circuitry

As stated above, the physical layout of the first processor circuitry comprising a plurality of (processor) cores may be obtained as described in the following approach: The concept of inferring a physical layout of a processor circuitry comprising a plurality of processor cores may comprise (one or some or all of) the following four phases: Phase 1: Collect temperature data (of the plurality of cores) by heating one core at a time using a power-intensive workload. When a particular core is running this power-intensive workload, all other cores may be idle. Phase 2: Use the collected temperature data and perform a linear regression between the heated core and all other cores. Phase 3: Perform a cluster analysis on the regression data to determine the nearby cores for each heated core. Phase 4: Correlate the nearby cores of every heated core to determine the physical layout of the processor circuitry on the die. These four phases are described in more detail below.

In a first phase of disclosed technique of inferring a physical layout of a processor circuitry comprising a plurality of processor cores may comprise collecting thermal telemetry data from each processor in the system under test. Therefore, for instance, publicly available performance registers may be used to monitor the core temperatures. For example, the following procedure may be carried out in this regard: 1. Collect all individual core temperatures (of all processor cores of a processor circuitry) in a predetermined time interval, for instance every 200 milliseconds or the like. 2. Bind a power-intensive workload to one core. This may result in the core being heated over time. 3. Stop collecting core temperatures. 4. Repeat steps 1,2 and 3 for every core in the processor circuitry (the system)

In a second phase of disclosed technique of inferring a physical layout of a processor circuitry comprising a plurality of processor cores may comprise performing a linear regression on the collected temperature data of phase 1. For example, the following procedure may be carried out in this regard: 1. Run a linear regression between the heated core and one other core of the processor circuitry and obtain a coefficient representing the temperature relationship between the two cores. 2. Repeat step 1 for every core on the system and obtain N-1 coefficients, where N is the number of processor cores in the processor circuitry (i.e., the system). 3. Repeat steps 1 and 2 for N datasets (each dataset being collected in phase 1 and corresponding to a different core being heated). After deducing the N-1 regression coefficients for each of the N processor cores an ordered list of coefficients (matrix) for each stressed core may be created.

A third phase of the disclosed technique of inferring a physical layout of a processor circuitry comprising a plurality of processor cores may comprise performing a cluster analysis on the table output of phase 2. This may be done using rule-based algorithms or machine learning algorithms known to the skilled person, such as a K-means algorithm. For instance, top 4-5 clusters may be identified. The cluster analysis may be performed by a K-means algorithm (for example K=4 or 5), based on the regression coefficients of one core obtained in phase 2. This clustering may be performed for each of the N-1 regression coefficients of the N cores, as obtained in phase 2. The identified clusters may have the following definitions: Cluster 1 maybe the processing core running a power-intensive workload. Cluster 2 maybe the closest cores to the processing core running a power-intensive workload, i.e., adjacent cores which are sharing a surface (with the processing core running a power-intensive workload). Cluster 3 maybe the second closest processing cores, i.e., edge cores which are sharing an edge (with the processing core running a power-intensive workload). Cluster 4 maybe [this may be for stacked/3D layouts only] third closest cores, i.e., kitty corner cores which are sharing a cube corner (with the processing core running a power-intensive workload). Cluster 5 maybe all the other cores which are likely separated by one or more cores from the heated core.

A fourth phase of the disclosed technique of inferring a physical layout of a processor circuitry comprising a plurality of processor cores may comprise correlating nearby cores of every heated core to determine physical layout. This may be based on the clustering results for each stressed core obtained in phase 3. Thereby, a possible physical layout (die layout) in 1D, 2D or 3D may be created programmatically. For instance, the process to map the processing cores according to their clustering/coefficient may be as follows: 1. Select a stressed core X (core running power-intensive workload), and in 3D space layout all of the cores in 2^{nd}, 3^{rd}, 4^{th} clusters in a way that maximizes thermal affinity and does not violate spatial rules (e.g. no more than 6x adjacent cores, 12x edge cores, etc.). m2. Pick a core from those surrounding core X, starting with cores in 2^{nd} cluster, then 3^{rd}, and then 4^{th}, and repeat step 1. for that core to fill out the nearby cores. This process stops when all cores in 2^{nd}, 3^{rd}, 4^{th} clusters have been mapped. 3. If there are cores that are not mapped in steps 1 and 2, repeat steps 1 and 2 until all cores in the system have been mapped (i.e. may result in many independent islands of mapped cores due to multiple tiles, dies or otherwise thermally isolated cores). 4. If there are multiple islands of mapped cores, orient them according to knowledge obtained from the cores that fall into 5^{th} cluster in phase 3.

### EXAMPLES

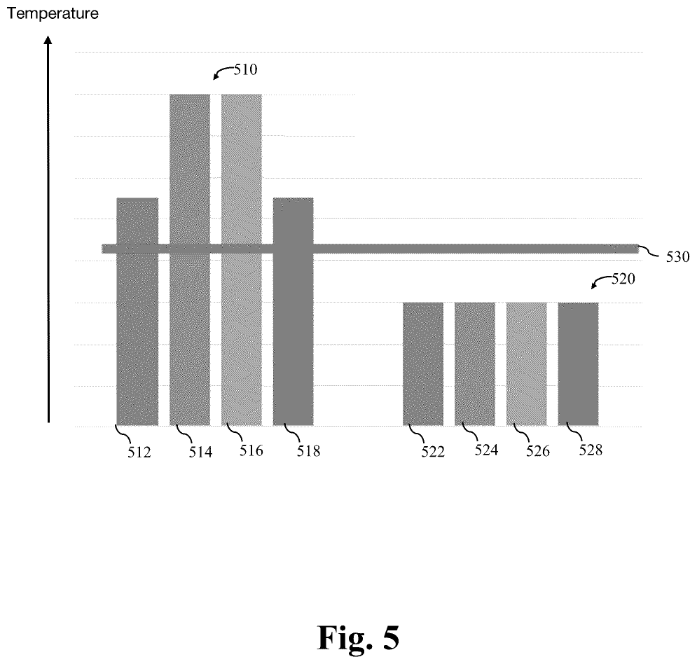

FIG. 3 illustrates a temperature (measurement) distribution 300 across a processor circuitry comprising a plurality of processor cores, by a core adjacency unaware scheduler. FIG. 3 shows the farer the cores is away from the heated cores 1-4 the lower is the temperature of the core (the darker the color of the core, the cooler the temperature of the core). That is cores 6-10 have a higher temperature than the cores 11-15 higher than 15-20 higher than 21-25. As depicted in FIG. 3, scheduling workloads on adjacent cores may lead to greater individual core temperatures. For example, the processor cores 1 and 4 each have a temperature of 55° C. For example, the processor cores 2 and 3 each have a temperature of 60° C. This may lead to the following disadvantages: Higher individual core temperatures may cause thermal throttles to be triggered resulting in reduced performance on the triggered cores. Higher concentration of heat in one area on the die may result in less efficient passive cooling from the heat sink which in-turn may require more active cooling which may lead to greater energy consumption by the cooling system. Higher individual core temperatures may result in greater thermal degradation and may reduce a lifespan of the affected cores (see also left side diagram in FIG. 5).

Further details and aspects are mentioned in connection with the examples described above or below. The example shown in FIG. 3 mayinclude one or more optional additional features corresponding to one or more aspects mentioned in connection with the proposed concept or one or more examples described above or below.

FIG. 4 illustrates a temperature (measurement) distribution 400 across a processor circuitry comprising a plurality of processor cores, by a core adjacency aware scheduler. The scheduler as proposed in this disclosure is aware of the core adjacencies. Therefore, workloads 1 to 4 maybe assigned to processor cores 1, 5, 21and 25. These processor cores are located in the corners of the processor circuitry and may therefore have a maximum distance to each other. Therefore, the disadvantages as described above may be mitigated.

For example, the processor cores 1, 5, 21and 25 each have a temperature of 50° C. which is lower than compared to FIG. 3. There may be significant performance and power improvements that a core adjacency aware scheduler as proposed in this disclosure may have (these improvements may apply to all modern processors and therefore at-scale the potential impact industry-wide would be even more significant).

There may be used as variety of scheduling algorithms, known to the skilled person. These algorithms may take into consideration the availability of resources and timing constraints. Any these existing algorithms may be enhanced by considering the physical layout of all cores in a die and their thermal characteristics as proposed in this disclosure. A core adjacency aware scheduler may schedule new workloads, or move existing workloads that are being thermally throttled, to cores that are physically distant and therefore less likely to be affected by temperature from adjacent cores.

Further details and aspects are mentioned in connection with the examples described above or below. The example shown in FIG. 4 mayinclude one or more optional additional features corresponding to one or more aspects mentioned in connection with the proposed concept or one or more examples described above or below.

FIG. 5 illustrates a core temperature comparison for the system of FIG. 3, i.e., chart 510, and the system of FIG. 4, i.e., chart 520. Chart 510 shows the temperature of the cores carrying out the workloads 1 to 4, wherein the workloads are allocated to the processor cores 1 to 4 without taken the temperature into account (see FIG. 3). That is the first core 512 (Nr. 1 in

FIG. 3) carries out workload 1, the second core 514 (Nr. 2 in FIG. 3) carries out workload 2, the third core (Nr. 3 in FIG. 3) 516 carries out workload 3, the fourth core (Nr. 4 in FIG. 3) 518 carries out workload 4. Processor cores 512 and 518 each have a temperature of 55° C. and processor cores 514 and 516 each have a temperature of 60° C. All cores have a temperature above a predefined thermal throttle threshold 530.

Chart 520 shows the temperature of the cores carrying out the workloads 1 to 4, wherein the workloads are allocated to the processor cores by taken the temperature into account (see FIG. 4) as described in this disclosure. That is the first core 522 (Nr. 1 in FIG. 3) carries out workload 1, the second core 524 (Nr. 5 in FIG. 3) carries out workload 2, the third core (Nr. 21 in FIG. 3) 526 carries out workload 3, the fourth core (Nr. 25 in FIG. 3) 528 carries out workload 4. The corresponding measured core temperatures is evenly distributed and therefore lower than on in chart 510. All cores have a temperature above a predefined thermal throttle threshold 530.

The proposed technique may be identified by monitoring the distribution of workloads across a die. If temperature-increasing workloads are running on physically distant cores, this could indicate use of a workload scheduler as proposed, which is aware of the physical layout of the die. Measuring the heat distribution across a die could be used to detect whether the proposed technique is used.

Further details and aspects are mentioned in connection with the examples described above or below. The example shown in FIG. 5 mayinclude one or more optional additional features corresponding to one or more aspects mentioned in connection with the proposed concept or one or more examples described above or below.

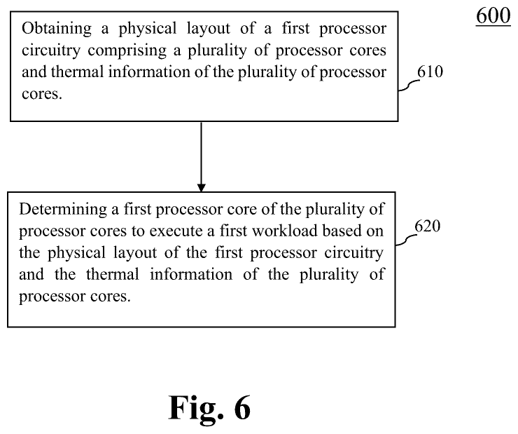

FIG. 6 illustrates a flowchart of an example of a method 600. The method 600 may for instance, be performed by an apparatus as described herein, such as apparatus 100. The method 600 comprises obtaining 610 a physical layout of a first processor circuitry comprising a plurality of processor cores and thermal information of the plurality of processor cores. The method 600 further comprises determining 620 a first processor core of the plurality of processor cores to execute a first workload based on the physical layout of the first processor circuitry and the thermal information of the plurality of processor cores.

More details and aspects of the method 600 are explained in connection with the proposed technique or one or more examples described above, e.g., with reference to FIG. 1. The method 600 may comprise one or more additional optional features corresponding to one or more aspects of the proposed technique, or one or more examples described above or below.

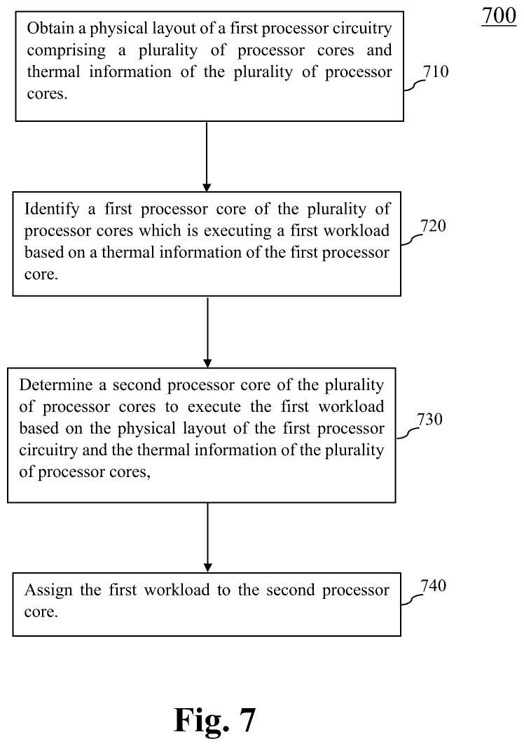

FIG. 7 illustrates a flowchart of an example of a method 700. The method 700 may for instance, be performed by an apparatus as described herein, such as apparatus 200. The method 700 comprises obtaining 710 a physical layout of a first processor circuitry comprising a plurality of processor cores and thermal information of the plurality of processor cores. The method 700 further comprises identify 720 a first processor core of the plurality of processor cores which is executing a first workload based on a thermal information of the first processor core. The method 700 further comprises determining 730 a second processor core of the plurality of processor cores to execute the first workload based on the physical layout of the first processor circuitry and the thermal information of the plurality of processor cores. A temperature measurement of the first core is higher than a temperature measurement of the second core. The method 700 further comprises assigning 740 the first workload to the second processor core.

More details and aspects of the method 700 are explained in connection with the proposed technique or one or more examples described above, e.g., with reference to FIG. 2. The method 700 may comprise one or more additional optional features corresponding to one or more aspects of the proposed technique, or one or more examples described above.

In the following, some examples of the proposed technique are presented:

In the following, some examples of the proposed concept are presented: An example (e.g., example 1) relates to an apparatus comprising interface circuitry, machine-readable instructions and processor circuitry to execute the machine-readable instructions to obtain a physical layout of a first processor circuitry comprising a plurality of processor cores and thermal information of the plurality of processor cores, determine a first processor core of the plurality of processor cores to execute a first workload based on the physical layout of the first processor circuitry and the thermal information of the plurality of processor cores.

Another example (e.g., example 2) relates to a previous example (e.g., example 1) or to any other example, further comprising that the thermal information of the plurality of processor cores comprises at least one of a temperature measurement for each of the plurality of cores, a thermal throttle threshold for each of the plurality of cores or a heat dissipation value for each of the plurality of cores.

Another example (e.g., example 3) relates to a previous example (e.g., one of the examples 1 to 2) or to any other example, further comprising that at least the first processor core has a lowest temperature measurement among the plurality of processor cores, the first processor has a temperature that is below a predetermined value, the first processor core has a temperature below a temperature measurement of at least half of the plurality of processor cores.

Another example (e.g., example 4) relates to a previous example (e.g., one of the examples 1 to 3) or to any other example, further comprising that the processor circuitry is to execute the machine-readable instructions to determine a second processor core of the plurality of processor cores to execute a second workload based on the physical layout of the first processor circuitry, the thermal information of the plurality of processor cores and/or the determined first processor core executing the first workload.

Another example (e.g., example 5) relates to a previous example (e.g., example 4) or to any other example, further comprising that the first processor core and/or the second processor core are determined such that at least the first processor core and the second processor core are not adjacent processor cores within the physical layout of the first processor circuitry, the first processor core and the second processor core have a predetermined spacing, a predetermined number of processor cores is between the first processor core and the second processor core, or a maximum possible spacing within the physical layout is between the first processor and the second processor.

Another example (e.g., example 6) relates to a previous example (e.g., one of the examples 1 to 5) or to any other example, further comprising that the processor circuitry is to execute the machine-readable instructions to determine a division of the physical layout of the first processor circuitry into a plurality of areas, wherein each area of the plurality of areas comprises one or more processor cores of the plurality of processor cores.

Another example (e.g., example 7) relates to a previous example (e.g., example 6) or to any other example, further comprising that the processor circuitry is to execute the machine-readable instructions to determine the first processor core as being part of a first area of the plurality of areas, the first area having a lowest average processor core temperature measurement.

Another example (e.g., example 8) relates to a previous example (e.g., example 7) or to any other example, further comprising that at least the first processor core is randomly chosen among the processor cores in the first area, or the first processor core is a processor core with the lowest processor core temperature measurement in the first area.

Another example (e.g., example 9) relates to a previous example (e.g., one of the examples 6 to 8) or to any other example, further comprising that the processor circuitry is to execute the machine-readable instructions to determine the second processor core as being part of a second area of the plurality of areas, the second area having the second lowest average processor core temperature measurement.

Another example (e.g., example 10) relates to a previous example (e.g., example 9) or to any other example, further comprising that at least the second processor core is randomly chosen among the processor cores in the second area, or the second processor core is a processor core with the lowest processor core temperature measurement in the second area.

Another example (e.g., example 11) relates to a previous example (e.g., one of the examples 6 to 10) or to any other example, further comprising that each area of the plurality of areas comprises an equal number of processors cores of the plurality of processor cores.

Another example (e.g., example 12) relates to a previous example (e.g., example 11) or to any other example, further comprising that each area of the plurality of areas comprises between 2 to 10 processors cores of the plurality of processor cores.

Another example (e.g., example 13) relates to a previous example (e.g., one of the examples 1 to 12) or to any other example, further comprising that the processor circuitry is to execute the machine-readable instructions to assign the first workload to the first processor core.

Another example (e.g., example 14) relates to a previous example (e.g., one of the examples 1 to 13) or to any other example, further comprising that the physical layout comprises a spatial positioning of the processor cores within the processor circuitry.

Another example (e.g., example 15) relates to a previous example (e.g., one of the examples 1 to 14) or to any other example, further comprising that the physical layout comprises a spatial positioning of the processor cores relative to each other within a 2-dimensional plane within the processor circuit.

Another example (e.g., example 15) relates to a previous example (e.g., one of the examples 1 to 15) or to any other example, further comprising that the first workload may be a task, a process, an application, or a virtual machine.

An example (e.g., example 16) relates to an apparatus comprising interface circuitry, machine-readable instructions and processor circuitry to execute the machine-readable instructions to obtain a physical layout of a first processor circuitry comprising a plurality of processor cores and thermal information of the plurality of processor cores, identify a first processor core of the plurality of processor cores which is executing a first workload based on a thermal information of the first processor core, determine a second processor core of the plurality of processor cores to execute the first workload based on the physical layout of the first processor circuitry and the thermal information of the plurality of processor cores, wherein a temperature measurement of the first core is higher than a temperature measurement of the second core, and assign the first workload to the second processor core.

An example (e.g., example 17) relates to an apparatus comprising processor circuitry configured to obtain a physical layout of a first processor circuitry comprising a plurality of processor cores and thermal information of the plurality of processor cores, determine a first processor core of the plurality of processor cores to execute a first workload based on the physical layout of the first processor circuitry and the thermal information of the plurality of processor cores.

An example (e.g., example 18) relates to a device comprising means for processing for obtaining a physical layout of a first processor circuitry comprising a plurality of processor cores and thermal information of the plurality of processor cores, determining a first processor core of the plurality of processor cores to execute a first workload based on the physical layout of the first processor circuitry and the thermal information of the plurality of processor cores

An example (e.g., example 19) relates to a method comprising obtaining a physical layout of a first processor circuitry comprising a plurality of processor cores and thermal information of the plurality of processor cores, determining a first processor core of the plurality of processor cores to execute a first workload based on the physical layout of the first processor circuitry and the thermal information of the plurality of processor cores.

Another example (e.g., example 20) relates to a previous example (e.g., example 19) or to any other example, further comprising that the thermal information of the plurality of processor cores comprises at least one of a temperature measurement for each of the plurality of cores, a thermal throttle threshold for each of the plurality of cores or a heat dissipation value for each of the plurality of cores.

Another example (e.g., example 21) relates to a previous example (e.g., one of the examples 19 to 20) or to any other example, further comprising that at least the first processor core has a lowest temperature measurement among the plurality of processor cores, the first processor has a temperature that is below a predetermined value, the first processor core has a temperature below a temperature measurement of at least half of the plurality of processor cores.

Another example (e.g., example 22) relates to a previous example (e.g., one of the examples 19 to 21) or to any other example, further comprising determining a second processor core of the plurality of processor cores to execute a second workload based on the physical layout of the first processor circuitry, the thermal information of the plurality of processor cores and/or the determined first processor core executing the first workload.

Another example (e.g., example 23) relates to a previous example (e.g., example 18) or to any other example, further comprising that the first processor core and/or the second processor core are determined such that at least the first processor core and the second processor core are not adjacent processor cores within the physical layout of the first processor circuitry, the first processor core and the second processor core have a predetermined spacing, a predetermined number of processor cores is between the first processor core and the second processor core, or a maximum possible spacing within the physical layout is between the first processor and the second processor.

Another example (e.g., example 24) relates to a previous example (e.g., one of the examples 19 to 23) or to any other example, further comprising determining a division of the physical layout of the first processor circuitry into a plurality of areas, wherein each area of the plurality of areas comprises one or more processor cores of the plurality of processor cores.

Another example (e.g., example 25) relates to a previous example (e.g., example 24) or to any other example, further comprising determining the first processor core as being part of a first area of the plurality of areas, the first area having a lowest average processor core temperature measurement.

Another example (e.g., example 26) relates to a previous example (e.g., example 25) or to any other example, further comprising that at least the first processor core is randomly chosen among the processor cores in the first area, or the first processor core is a processor core with the lowest processor core temperature measurement in the first area.

Another example (e.g., example 27) relates to a previous example (e.g., one of the examples 24 to 26) or to any other example, further comprising determining the second processor core as being part of a second area of the plurality of areas, the second area having the second lowest average processor core temperature measurement.

Another example (e.g., example 28) relates to a previous example (e.g., example 27) or to any other example, further comprising that at least the second processor core is randomly chosen among the processor cores in the second area, or the second processor core is a processor core with the lowest processor core temperature measurement in the second area.

Another example (e.g., example 29) relates to a previous example (e.g., one of the examples 24 to 28) or to any other example, further comprising that each area of the plurality of areas comprises an equal number of processors cores of the plurality of processor cores.

Another example (e.g., example 30) relates to a previous example (e.g., example 29) or to any other example, further comprising that each area of the plurality of areas comprises between 2 to 10 processors cores of the plurality of processor cores.

Another example (e.g., example 31) relates to a previous example (e.g., one of the examples 19 to 30) or to any other example, further comprising assigning the first workload to the first processor core.

Another example (e.g., example 32) relates to a previous example (e.g., one of the examples 19 to 31) or to any other example, further comprising that the physical layout comprises a spatial positioning of the processor cores within the processor circuitry.

Another example (e.g., example 33) relates to a previous example (e.g., one of the examples 19 to 32) or to any other example, further comprising that the physical layout comprises a spatial positioning of the processor cores relative to each other within a 2-dimensional plane within the processor circuit.

Another example (e.g., example 34) relates to a previous example (e.g., one of the examples 19 to 33) or to any other example, further comprising that the first workload may be a task, a process, an application, or a virtual machine.

An example (e.g., example 35) relates to a method comprising obtaining a physical layout of a first processor circuitry comprising a plurality of processor cores and thermal information of the plurality of processor cores, identifying a first processor core of the plurality of processor cores which is executing a first workload based on a thermal information of the first processor core, determining a second processor core of the plurality of processor cores to execute the first workload based on the physical layout of the first processor circuitry and the thermal information of the plurality of processor cores, wherein a temperature measurement of the first core is higher than a temperature measurement of the second core, and assigning the first workload to the second processor core.

Another example (e.g., example 36) relates to a non-transitory machine-readable storage medium including program code, when executed, to cause a machine to perform the method of examples 19 to 34.

Another example (e.g., example 37) relates to a computer program having a program code for performing the method of examples 19 to 34 when the computer program is executed on a computer, a processor, or a programmable hardware component.

Another example (e.g., example 38) relates to a machine-readable storage including machine readable instructions, when executed, to implement a method or realize an apparatus as described in any pending example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor-or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions and processor circuitry to execute the machine-readable instructions to:
obtain a physical layout of a first processor circuitry comprising a plurality of processor cores and thermal information of the plurality of processor cores;
determine a first processor core of the plurality of processor cores to execute a first workload based on the physical layout of the first processor circuitry and the thermal information of the plurality of processor cores.

2. The apparatus according to claim 1, wherein the thermal information of the plurality of processor cores comprises at least one of a temperature measurement for each of the plurality of cores, a thermal throttle threshold for each of the plurality of cores or a heat dissipation value for each of the plurality of cores.

3. The apparatus according to claim 1, wherein at least
the first processor core has a lowest temperature measurement among the plurality of processor cores, the first processor has a temperature that is below a predetermined value, the first processor core has a temperature below a temperature measurement of at least half of the plurality of processor cores.

4. The apparatus according to claim 1, wherein the processor circuitry is to execute the machine-readable instructions to determine a second processor core of the plurality of processor cores to execute a second workload based on the physical layout of the first processor circuitry, the thermal information of the plurality of processor cores and/or the determined first processor core executing the first workload.

5. The apparatus according to claim 4, wherein the first processor core and/or the second processor core are determined such that at least
the first processor core and the second processor core are not adjacent processor cores within the physical layout of the first processor circuitry, the first processor core and the second processor core have a predetermined spacing, a predetermined number of processor cores is between the first processor core and the second processor core, or a maximum possible spacing within the physical layout is between the first processor and the second processor.

6. The apparatus according to claim 1, wherein the processor circuitry is to execute the machine-readable instructions to determine a division of the physical layout of the first processor circuitry into a plurality of areas, wherein each area of the plurality of areas comprises one or more processor cores of the plurality of processor cores.

7. The apparatus according to claim 6, wherein the processor circuitry is to execute the machine-readable instructions to determine the first processor core as being part of a first area of the plurality of areas, the first area having a lowest average processor core temperature measurement.

8. The apparatus according to claim 7, wherein at least
the first processor core is randomly chosen among the processor cores in the first area, or the first processor core is a processor core with the lowest processor core temperature measurement in the first area.

9. The apparatus according to claim 6, wherein the processor circuitry is to execute the machine-readable instructions to determine the second processor core as being part of a second area of the plurality of areas, the second area having the second lowest average processor core temperature measurement.

10. The apparatus according to claim 9, wherein at least
the second processor core is randomly chosen among the processor cores in the second area, or the second processor core is a processor core with the lowest processor core temperature measurement in the second area.

11. The apparatus according to claim 6, wherein each area of the plurality of areas comprises an equal number of processors cores of the plurality of processor cores.

12. The apparatus according to claim 11, wherein each area of the plurality of areas comprises between 2 to 10 processors cores of the plurality of processor cores.

13. The apparatus according to claim 1, wherein the processor circuitry is to execute the machine-readable instructions to assign the first workload to the first processor core.

14. The apparatus according to claim 1, wherein the physical layout comprises a spatial positioning of the processor cores within the processor circuitry.

15. The apparatus according to claim 1, wherein the physical layout comprises a spatial positioning of the processor cores relative to each other within a 2-dimensional plane within the processor circuit.

16. An apparatus comprising interface circuitry, machine-readable instructions and processor circuitry to execute the machine-readable instructions to:
obtain a physical layout of a first processor circuitry comprising a plurality of processor cores and thermal information of the plurality of processor cores;
identify a first processor core of the plurality of processor cores which is executing a first workload based on a thermal information of the first processor core;
determine a second processor core of the plurality of processor cores to execute the first workload based on the physical layout of the first processor circuitry and the thermal information of the plurality of processor cores,
wherein a temperature measurement of the first core is higher than a temperature measurement of the second core; and
assign the first workload to the second processor core.

17. A method comprising:
obtaining a physical layout of a first processor circuitry comprising a plurality of processor cores and thermal information of the plurality of processor cores;
determining a first processor core of the plurality of processor cores to execute a first workload based on the physical layout of the first processor circuitry and the thermal information of the plurality of processor cores.

18. The method according to claim 17, further comprising determining a second processor core of the plurality of processor cores to execute a second workload based on the physical layout of the first processor circuitry, the thermal information of the plurality of processor cores and/or the determined first processor core executing the first workload.

19. The method according to claim 17, further comprising determining a division of the physical layout of the first processor circuitry into a plurality of areas, wherein each area of the plurality of areas comprises one or more processor cores of the plurality of processor cores.

20. The method according to claim 19, further comprising determining the first processor core as being part of a first area of the plurality of areas, the first area having a lowest average processor core temperature measurement.
